(19) United States
(12) Patent Application Publication
(10) Pub. No.: US 2020/0302937 A1
(43) Pub. Date: Sep. 24, 2020

(54) AGENT SYSTEM, SERVER DEVICE, METHOD OF CONTROLLING AGENT SYSTEM, AND COMPUTER-READABLE NON-TRANSIENT STORAGE MEDIUM

(71) Applicant: HONDA MOTOR CO., LTD., Tokyo (JP)

(72) Inventors: Sawako Furuya, Wako-shi (JP); Kengo Naiki, Wako-shi (JP); Hiroki Nakayama, Wako-shi (JP); Yoshifumi Wagatsuma, Wako-shi (JP)

(21) Appl. No.: 16/823,897

(22) Filed: Mar. 19, 2020

(30) Foreign Application Priority Data
Mar. 22, 2019 (JP) 2019-054892

(51) Int. Cl. G10L 15/30; G10L 15/32; B60W 50/14; B60K 35/00

(52) U.S. Cl. CPC G10L 15/30; G10L 15/32; B60K 2370/148; B60K 35/00; B60W 50/14

(57) ABSTRACT

In an agent system, a first server device transmits information associated with a speech of a first user acquired from a first terminal device to a second server device, and the second server device transmits information associated with the speech of the first user acquired from the first server device to a second terminal device or an on-vehicle agent device on the basis of existence of a second user recognized by the second terminal device or the on-vehicle agent device.

### CROSS-REFERENCE TO RELATED APPLICATION

Priority is claimed on Japanese Patent Application No. 2019-054892, filed Mar. 22, 2019, the content of which is incorporated herein by reference.

### BACKGROUND OF THE INVENTION

### Field of the Invention

The present invention relates to an agent system, a server device, a method of controlling an agent system, and a computer-readable non-transient storage medium.

### Description of Related Art

In the related art, a technology associated with an agent function that provides information associated with driving assistance according to requirements of an occupant, control of a vehicle, other applications, or the like, while performing conversation with the occupant in the vehicle has been disclosed (for example, see Japanese Unexamined Patent Application, First Publication No. 2006-335231).

### SUMMARY OF THE INVENTION

In recent years, while practical applications of providing agent functions installed in a vehicle to a second user by transmitting a notification from a first user located outside the vehicle to the vehicle using a network connection have been promoted, a method of providing agent functions using network connection has not been sufficiently studied. For this reason, in the related art, in some cases, providing agent functions to a second user based on notification from a first user was not performed suitably.

An aspect of the present invention is directed to providing an agent system, a server device, a method of controlling an agent system, and a computer-readable non-transient storage medium, which are capable of suitably performing provision of agent functions.

An agent system, a server device, a method of controlling an agent system, and a computer-readable non-transient storage medium according to the present invention employ the following configurations.

(1) An agent system according to an aspect of the present invention includes a first agent application that causes a first terminal device used by a first user to function as a first agent device configured to provide a service including causing an output section to output a response by a voice in response to a speech of the first user; a first server device configured to communicate with the first terminal device; a second agent application that causes a second terminal device used by a second user to function as a second agent device configured to provide a service including causing an output section to output a response by a voice in response to a speech of the second user; an on-vehicle agent device mounted on a vehicle and used by the second user; and a second server device configured to communicate with the second terminal device, the on-vehicle agent device and the first server device, wherein the first server device transmits information associated with a speech of the first user acquired from the first terminal device to the second server device, and the second server device transmits information associated with the speech of the first user acquired from the first server device to the second terminal device or the on-vehicle agent device on the basis of existence of the second user recognized by the second terminal device or the on-vehicle agent device.

(2) In the aspect of the above-mentioned (1), the second server device may transmit information associated with the speech of the first user to the on-vehicle agent device when the second user is recognized by the on-vehicle agent device.

(3) In the aspect of the above-mentioned (1) or (2), the second server device may transmit information associated with the speech of the first user to the second terminal device when the second user is recognized by the second terminal device.

(4) In the aspect of the above-mentioned (2) or (3), the second server device may transmit information associated with the speech of the first user to the on-vehicle agent device or the second terminal device provided that the information associated with the speech of the first user is determined as an object to be transmitted to the second user.

(5) A server device according to another aspect of the present invention that functions as a first server device which is configured to communicate with a first terminal device that functions as a first agent device configured to provide a service including causing an output section to output a response by a voice in response to a speech of a first user, a second terminal device which functions as a second agent device configured to provide a service including causing an output section to output a response by a voice in response to a speech of a second user, and a second server device which is configured to communicate with an on-vehicle agent device mounted on a vehicle and used by the second user, wherein the first server device acquires information associated with the speech of the first user acquired from the first terminal device, and transmits information associated with the speech of the first user acquired from the first server device to the second terminal device or the on-vehicle agent device on the basis of existence of the second user recognized by the second terminal device or the on-vehicle agent device.

(6) A method of controlling an agent system according to another aspect of the present invention, which is performed by one or a plurality of computers, the method including: providing a service including causing an output section to output a response by a voice in response to a speech of a first user through a first terminal device used by the first user; providing a service including causing an output section to output a response by a voice in response to a speech of a second user through a second terminal device used by the second user; recognizing existence of the second user through an on-vehicle agent device mounted on a vehicle and used by the second user or the second terminal device; and transmitting information associated with the speech of the first user to the second terminal device or the on-vehicle agent device on the basis of existence of the second user.

(7) A computer-readable non-transient storage medium according to another aspect of the present invention storing a program executed in one or plurality of computers, the program stored in the computer-readable non-transient storage medium including: processing of providing a service including causing an output section to output a response by a voice in response to a speech of a first user through a first terminal device used by the first user; processing of providing a service including causing an output section to output a response by a voice in response to a speech of a second user through a second terminal device used by the second user; processing of recognizing existence of the second user through an on-vehicle agent device mounted on a vehicle and used by the second user or the second terminal device; and processing of transmitting information associated with the speech of the first user to the second terminal device or the on-vehicle agent device on the basis of existence of the second user.

According to the aspect of the above-mentioned (1) to (7), provision of an agent function can be accurately performed.

### BRIEF DESCRIPTION OF THE DRAWINGS

FIG. 1 is a view showing a configuration of an agent system.

FIG. 2 is a view showing a configuration of an on-vehicle agent device and instruments mounted on a vehicle.

FIG. 3 is a view showing an arrangement example of display and operation device.

FIG. 4 is a view showing a configuration of an agent server and a part of a configuration of the on-vehicle agent device.

FIG. 5 is a view for describing an example of transmission switching database.

FIG. 6 is a flowchart for describing a flow of a series of processing of the agent server.

FIG. 7 is a view for describing an operation of the agent system.

FIG. 8 is a view for describing an operation of the agent system.

### DETAILED DESCRIPTION OF THE INVENTION

Hereinafter, embodiments of an agent system, a server device, a method of controlling an agent system, and a computer-readable non-transient storage medium of the present invention will be described with reference to the accompanying drawings. The agent device is a device configured to realize a part or all of the agent system. Hereinafter, as an example of the agent device, the agent device including a plurality of types of agent functions will be described. The agent function is, for example, a function that provides various types of information based on requirements (commands) contained in speech of an occupant in a vehicle M or mediates network services while conversing with the occupant. The plurality of types of agents may have different functions, processing sequences, controls, output aspects and contents, which are carried out respectively. In addition, some of the agent functions may have functions that perform control or the like of instruments in the vehicle (for example, instruments associated with driving control or vehicle body control).

The agent functions are realized by integrally using, for example, a natural language processing function (a function of understanding a structure or meaning of text), a conversation management function, a network searching function of searching another device via a network or searching predetermined database provided in a host device, or the like, in addition to a voice recognition function of recognizing voice of an occupant (a function of converting voice into text). Some or all of the functions may be realized by an artificial intelligence (AI) technology. In addition, a part of the configuration of performing the functions (in particular, a voice recognition function or a natural language processing interpretation function) may be mounted on an agent server (an external device) that can communicate with an on-vehicle communication device of the vehicle M or a general purpose communication device brought into the vehicle M. In the following description, it is assumed that a part of the configuration is mounted on the agent server, and the agent device and the agent server cooperate to realize the agent system. In addition, a service provider (a service entity) that virtually appears in cooperation with the agent device and the agent server is referred to as an agent.

### Entire Configuration

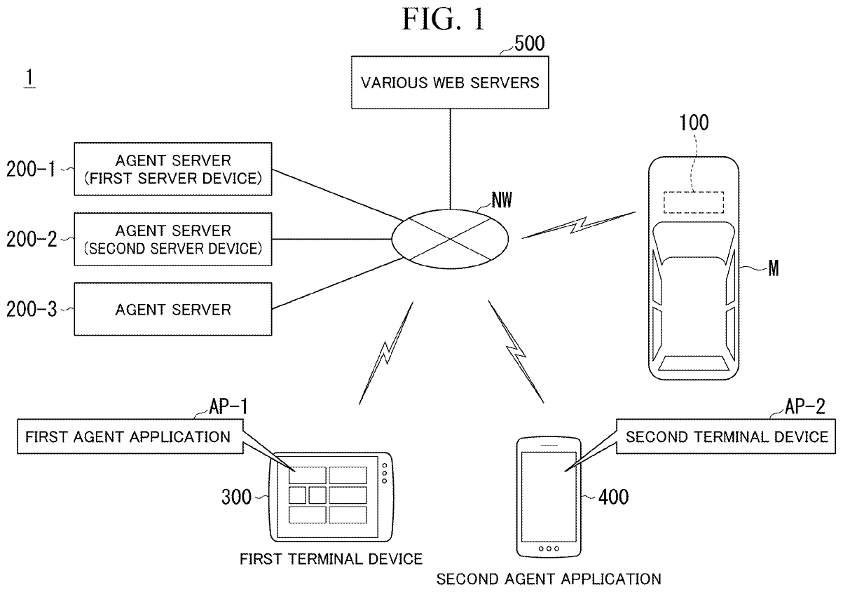

FIG. 1 is a configuration view of an agent system 1. The agent system 1 includes, for example, an on-vehicle agent device 100, a plurality of agent servers 200-1, 200-2 and 200-3, a first terminal device 300 and a second terminal device 400. The numbers after the hyphen at the ends of the numerals are identifiers for distinguishing the agents. In the embodiment, the agent server 200-1 is an example of “a first server device,” and the agent server 200-2 is an example of “a second server device.” In addition, when there is no distinction which agent server is provided, it may be simply referred as an agent server 200.

While three agent servers 200 are shown in FIG. 1, the number of the agent servers 200 may be two, or may be four or more. The agent servers 200 are managed by providers of agent systems that are different from each other. Accordingly, the agents according to the present invention are agents realized by different providers. As the providers, for example, a car manufacturer, a network service business operator, an electronic commerce business operator, a portable terminal seller or manufacturer, and the like, are exemplified, and an arbitrary subject (a corporation, a group, a private person, or the like) may become a provider of an agent system.

The on-vehicle agent device 100 is in communication with the agent server 200 via a network NW. The network NW includes, for example, some or all of the Internet, a cellular network, a Wi-Fi network, a wide area network (WAN), a local area network (LAN), a public line, a telephone line, a radio base station, and the like. The first terminal device 300, the second terminal device 400, and various types of web servers 500 are connected to the network NW. The on-vehicle agent device 100, the agent server 200, the first terminal device 300, or the second terminal device 400 can obtain web pages from the various types of web servers 500 via the network NW.

The on-vehicle agent device 100 performs conversation with the occupant in the vehicle M, transmits voice from the occupant to the agent server 200, and suggests a reply obtained from the agent server 200 to the occupant in a form of voice output or image display.

The first terminal device 300 is used by a first user and functions as a first agent device by executing a first agent application AP-1 installed in the first terminal device 300. In the embodiment, the first terminal device 300 cooperates with the agent server 200-1 to make the agent appear by executing the first agent application AP-1, and provides a service including causing an output section to output a response by the voice in response to the speech of the first user input to the first terminal device 300. Further, the first terminal device 300 may be, for example, a terminal device that can be carried by the first user, or may be a terminal device installed at a predetermined place such as home, facility, etc.

The second terminal device 400 is used by a second user and functions as a second agent device by executing a second agent application AP-2 installed in the second terminal device 400. In the embodiment, the second terminal device 400 cooperates with the agent server 200-2 to make the agent appear by executing the second agent application AP-2, and provides a service including causing the output section to output a response by the voice in response to the speech of the second user input into the second terminal device 400. Further, the second terminal device 400 is, for example, a terminal device that can be carried by the second user. When the second user is on the vehicle M, the second terminal device 400 is present in the vehicle M, and when the second user is not on the vehicle M, the second terminal device 400 is present at a position away from the vehicle M.

### Vehicle

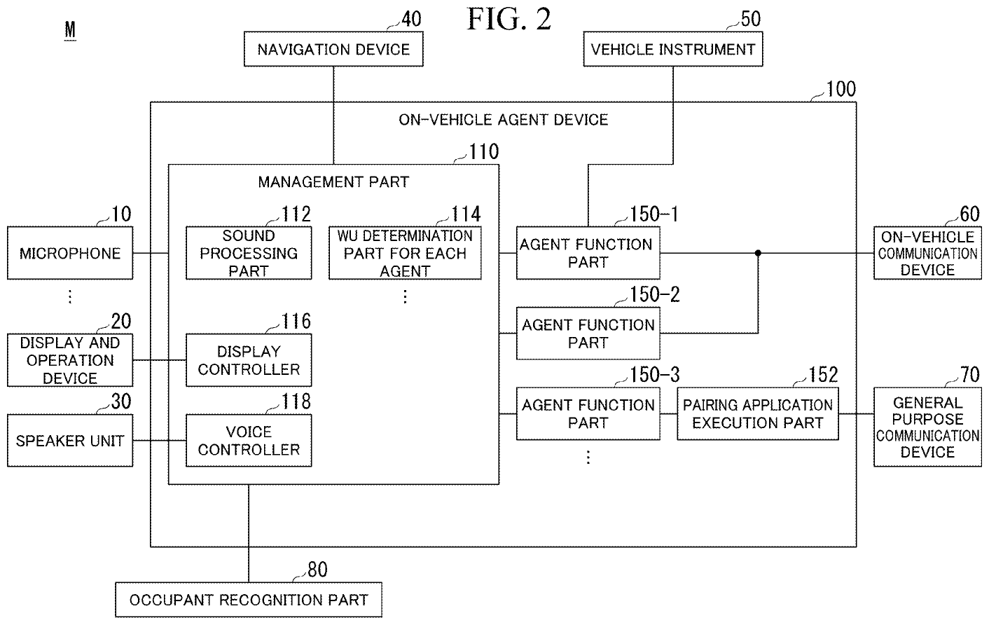

FIG. 2 is a view showing a configuration of the on-vehicle agent device 100 according to the embodiment and instruments mounted on the vehicle M. For example, one or more microphones 10, display and operation device 20, a speaker unit 30 (an output section), a navigation device 40, a vehicle instrument 50, an on-vehicle communication device 60, an occupant recognition device 80 and the on-vehicle agent device 100 are mounted on the vehicle M. In addition, a general purpose communication device 70 such as a smartphone or the like may be brought into a passenger compartment and used as a communication device. These devices are connected to each other via a multiple communication line such as a controller area network (CAN) communication line or the like, a serial communication line, a wireless communication network, or the like. Further, the configuration shown in FIG. 2 is merely an example, and a part of the configuration may be omitted or another configuration may be added.

The microphone 10 is a sound pickup part configured to collect voice emitted in the passenger compartment. The display and operation device 20 is a device (or a device group) configured to receive input operations while displaying image. The display and operation device 20 includes a display device configured as, for example, a touch panel. The display and operation device 20 may further include a head up display (HUD) or a mechanical input device. The speaker unit 30 includes, for example, a plurality of speakers (sound output sections) disposed at difference positions in the passenger compartment. The display and operation device 20 may be shared by the on-vehicle agent device 100 and the navigation device 40. Detailed description thereof will be followed.

The navigation device 40 includes a navigation human machine interface (HMI), a global positioning device such as a global positioning system (GPS) or the like, a storage device on which map information is stored, and a control device (a navigation controller) configured to perform route search or the like. Some or all of the microphone 10, the display and operation devices 20 and the speaker unit 30 may be used as a navigation HMI. The navigation device 40 searches a route (a navigation route) to move from a position of the vehicle M identified by the global positioning system device to a destination input by the occupant, and outputs guide information using the navigation HMI such that the vehicle M can travel along the route.

The route search function may be provided in the navigation server that is accessible via the network NW. In this case, the navigation device 40 acquires a route from the navigation server and outputs guide information. Further, the on-vehicle agent device 100 may be built on the basis of a navigation controller, and in this case, the navigation controller and the on-vehicle agent device 100 are integrally configured on hardware.

The vehicle instrument 50 includes, for example, a driving force output device such as an engine, a traveling motor, or the like, a starting motor of the engine, a door lock device, a door opening/closing device, a window, a window opening/closing device and a window opening/closing control device, a seat, a seat position control device, a rearview mirror, an angle and a position control device of the rearview mirror, illumination devices inside and outside the vehicle and control devices thereof, a wiper or a defogger and a control device thereof, a direction indicator lamp and a control device thereof, an air-conditioning device, a vehicle information device containing information of a traveling distance or pneumatic pressures of tires, residual quantity information of fuel, or the like, or the like.

The on-vehicle communication device 60 is, for example, a wireless communication device that is accessible to the network NW using a cellular network or a Wi-Fi network.

The occupant recognition device 80 includes, for example, a seating sensor, a camera in the passenger compartment, an image recognition device, and the like.

The seating sensor includes a pressure sensor provided on a lower section of the seat, a tension sensor attached to the seat belt, and the like. The camera in the passenger compartment is a charge coupled device (CCD) camera or a complementary metal oxide semiconductor (CMOS) camera provided in the passenger compartment. The image recognition device analyzes an image of the camera in the passenger compartment, and recognizes existence of an occupant on each seat, a face orientation, and the like. The occupant recognition device 80 identifies a user by performing authentication processing such as face authentication, voiceprint authentication, or the like, with respect to the user when the user is recognized. In addition, the occupant recognition device 80 recognizes presence of a user on the basis of whether authentication processing with respect to the user is established.

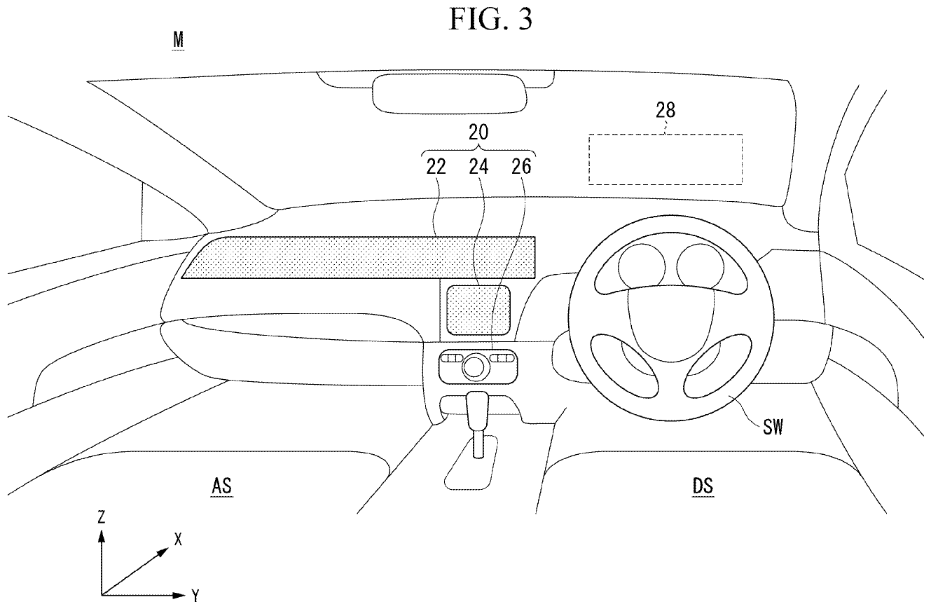

FIG. 3 is a view showing an arrangement example of the display and operation device 20. The display and operation device 20 includes, for example, a first display 22, a second display 24 and an operation switch ASSY 26. The display and operation device 20 may further include an HUD 28.

In the vehicle M, for example, a driver's seat DS on which a steering wheel SW is provided, and an assistant driver's seat AS provided in a vehicle width direction (a Y direction in the drawings) with respect to the driver's seat DS, are present. The first display 22 is a laterally elongated display device extending from a middle area in an installment panel between the driver's seat DS and the assistant driver's seat AS to a position facing a left end portion of the assistant driver's seat AS.

The second display 24 is located in the middle between the driver's seat DS and the assistant driver's seat AS in the vehicle width direction and below the first display. For example, the first display 22 and the second display 24 are both configured as a touch panel, and include a liquid crystal display (LCD), organic electroluminescence (EL), a plasma display, or the like, as a display section. The operation switch ASSY 26 is an assembly in which dial switches, button type switches, and the like, are integrated. The display and operation devices 20 output contents of operations performed by the occupant to the on-vehicle agent device 100. The contents displayed by the first display 22 or the second display 24 may be determined by the on-vehicle agent device 100.

### Agent Device

Returning to FIG. 2, the on-vehicle agent device 100 includes a management part 110, agent function parts 150-1, 150-2 and 150-3, and a pairing application execution part 152. The management part 110 includes, for example, a sound processing part 112, a wake up (WU) determination part 114 for each agent, a display controller 116 and a voice controller 118. When it does not distinguish which agent function part, it is simply referred to as the agent function parts 150. Illustration of the three agent function parts 150 is merely an example corresponding to the number of the agent servers 200 in FIG. 1, and the number of the agent function parts 150 may be two, or four or more. Software layout shown in FIG. 2 is shown for the sake of simple explanation, and in fact, for example, the software layout can be arbitrarily modified such that the management part 110 is interposed between the agent function parts 150 and the on-vehicle communication device 60.

The components of the on-vehicle agent device 100 are realized by executing a program (software) using a hardware processor such as a central processing unit (CPU) or the like. Some or all of these components may be realized by hardware (a circuit part; including circuitry) such as large scale integration (LSI), an application specific integrated circuit (ASIC), a field-programmable gate array (FPGA), a graphics processing unit (GPU), or the like, or may be realized by cooperation of the software and the hardware. The program may be previously stored on a storage device such as a hard disk drive (HDD), a flash memory, or the like (a storage device including a non-transient storage medium), or the program may be stored on a detachable storage medium (non-transient storage medium) such as DVD, CD-ROM, or the like, and may be installed as the storage medium is mounted on a drive device.

The management part 110 functions as a program such as an operating system (OS), middleware, or the like, is executed.

The sound processing part 112 of the management part 110 performs sound processing on the input sound so as to be in a state in which wake-up-words preset for each agent are appropriately recognized.

The WU determination part 114 for each agent recognizes the wake-up-words present to correspond to the agent function parts 150-1, 150-2 and 150-3 and predetermined for each agent. The WU determination part 114 for each agent recognizes meaning of the voice from the voice (voice stream) on which sound processing is performed. First, the WU determination part 114 for each agent detects a voice section on the basis of amplitude and zero crossing of a voice waveform in the voice stream. The WU determination part 114 for each agent may perform section detection based on voice identification and non-voice identification of a frame unit based on a Gaussian mixture model (GMM).

Next, the WU determination part 114 for each agent converts the voice in the detected voice section into text and sets the text as character information. Then, the WU determination part 114 for each agent determines whether texted character information corresponds to the wake-up-word. When it is determined that the texted character information is the wake-up-word, the WU determination part 114 for each agent starts the corresponding agent function part 150. Further, the function corresponding to the WU determination part 114 for each agent may be mounted on the agent server 200. In this case, the management part 110 transmits the voice stream on which the sound processing is performed by the sound processing part 112 to the agent server 200, and when the agent server 200 determines that the voice stream is a wake-up-word, the agent function part 150 is started according to an instruction from the agent server 200. Further, each of the agent function parts 150 may be always running and perform determination of the wake-up-word by itself. In this case, it is not necessary for the management part 110 to include the WU determination part 114 for each agent.

The agent function part 150 cooperates with the corresponding agent server 200 to make the agent appear, and provides a service including causing the output section to output a response by the voice in response to the speech of the occupant in the vehicle. The agent function parts 150 may include those authorized to control the vehicle instrument 50. In addition, some of the agent function parts 150 may communicate with the agent server 200 in cooperation with the general purpose communication device 70 via the pairing application execution part 152.

For example, the agent function part 150-1 has the authority to control the vehicle instrument 50. The agent function part 150-1 is in communication with the agent server 200-1 via the on-vehicle communication device 60. The agent function part 150-2 is in communication with the agent server 200-2 via the on-vehicle communication device 60. The agent function part 150-3 cooperates with the general purpose communication device 70 via the pairing application execution part 152 and is in communication with the agent server 200-3. The pairing application execution part 152 performs pairing with the general purpose communication device 70 using, for example, Bluetooth (registered trade name), and connects the agent function part 150-3 and the general purpose communication device 70. Further, the agent function part 150-3 may be connected to the general purpose communication device 70 through wired communication using a universal serial bus (USB) or the like.

The display controller 116 displays an image on the first display 22 or the second display 24 according to the instruction from the agent function part 150. The display controller 116 generates, for example, an anthropomorphic image of the agent (hereinafter, referred to as an agent image) that performs communication with the occupant in the passenger compartment according to the control of some of the agent function parts 150, and displays the generated agent image on the first display 22. The agent image is, for example, an image of a mode of talking to the occupant. The agent image may include, for example, a face image to a level at which expression or a face orientation is recognized by at least a viewer (occupant). For example, in the agent image, parts imitating the eyes and the nose are represented in the face region, and the expression or the face orientation may be recognized on the basis of the positions of the parts in the face region. In addition, the agent image may be felt three-dimensionally, the face orientation of the agent may be recognized by the viewer by including a head image in a three-dimensional space, or an action, a behavior, a posture, or the like, of the agent may be recognized by including an image of a main body (a torso, or hands and feet). In addition, the agent image may be an animation image.

The voice controller 118 causes some or all of the speakers included in the speaker unit 30 to output the voice according to the instruction from the agent function parts 150. The voice controller 118 may perform control of localizing the sound image of the agent voice at a position corresponding to the display position of the agent image using the plurality of speaker units 30. The position corresponding to the display position of the agent image is, for example, a position at which the occupant is expected to feel that the agent image is speaking the agent voice, and specifically, is a position in the vicinity of the display position of the agent image. In addition, the localization of the sound image is to determine, for example, a spatial position of the sound source felt by the occupant by adjusting loudness of the sound transmitted to the left and right ears of the occupant.

### Agent Server

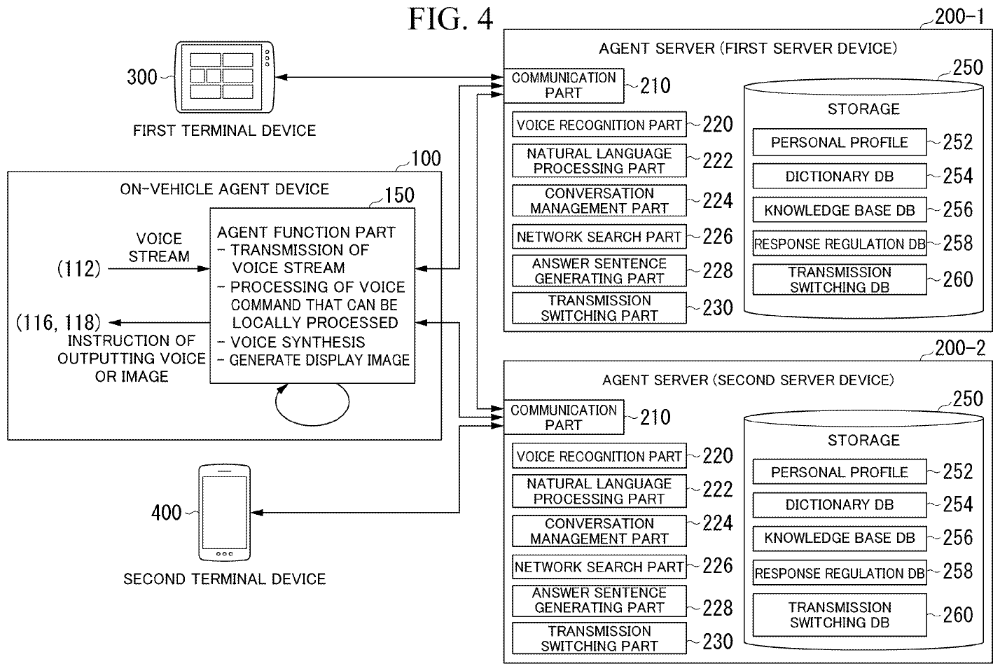

FIG. 4 is a view showing a configuration of the agent server 200 and a part of a configuration of the on-vehicle agent device 100. Hereinafter, on behalf of the agent server 200, operations of the agent function parts 150 or the like will be described together with the configuration of the agent server 200-1 and the agent server 200-2. Here, description of physical communication from the on-vehicle agent device 100 to the network NW will be omitted.

The agent server 200-1 and the agent server 200-2 include communication parts 210. The communication parts 210 are, for example, network interfaces such as a network interface card (NIC) and the like. Further, the agent server 200-1 and the agent server 200-2 include, for example, voice recognition parts 220, natural language processing parts 222, conversation management parts 224, network search parts 226, answer sentence generating parts 228, and transmission switching parts 230. These components are realized by executing, for example, a program (software) using a hardware processor such as a CPU or the like. Some or all of these components may be realized by hardware (a circuit part; including circuitry) such as an LSI, ASIC, FPGA, GPU, or the like, or may be realized by cooperation of software and hardware. The program may be previously stored on a storage device such as a HDD, a flash memory, or the like (a storage device including a non-transient storage medium), or the program may be stored on a detachable storage medium (a non-transient storage medium) such as a DVD, a CD-ROM, or the like, and installed as a storage medium is mounted a drive device.

The agent server 200-1 and the agent server 200-2 include storages 250. The storages 250 are realized by various types of storage devices. Personal profiles 252, dictionary databases (DBs) 254, knowledge-based DBs 256, response regulation DBs 258, and transmission switching DBs 260 are stored on the storages 250.

In the on-vehicle agent device 100, the agent function parts 150 transmits the voice stream, or a voice stream on which processing such as compression, encoding, or the like, is performed, to the agent servers 200-1 and 200-2. The agent function parts 150 may perform processing required by the voice command when a voice command that can be locally processed (processing that does not pass through the agent servers 200-1 and 200-2) is recognized. A voice command that can be locally processed is a voice command that can be replied to by referring to the storage (not shown) included in the on-vehicle agent device 100, or a voice command that controls the vehicle instrument 50 (for example, a command or the like to turn on the air-conditioning device) in the case of the agent function part 150-1. Accordingly, the agent function parts 150 may have some of the functions included in the agent servers 200-1 and 200-2.

When the voice stream is obtained, the voice recognition parts 220 perform voice recognition and outputs text information, and the natural language processing parts 222 performs meaning interpretation thereon while referring to the dictionary DBs 254 with respect to the character information. The dictionary DBs 254 are DBs in which abstracted meaning information is associated with the character information. The dictionary DBs 254 may include table information of synonyms or near synonyms.

The processing of the voice recognition parts 220 and the processing of the natural language processing parts 222 need not be clearly separate, and may interact with each other such that the voice recognition parts 220 receive the processing result of the natural language processing parts 222 and modify the recognition result.

When a meaning such as “Today's weather?” or “How is the weather?” is recognized as a recognition result, the natural language processing parts 222 generates, for example, a command replacing with standard character information “Today's weather”. Accordingly, even if there is variation in the wording of the text of a request, it is possible to easily perform a required conversation. In addition, the natural language processing parts 222 may recognize, for example, the meaning of the character information using artificial intelligence processing such as machine learning processing using a probability or the like, and generate a command based on the recognition result.

The conversation management parts 224 determine contents of speech made to the occupant in the vehicle M while referring the personal profiles 252, the knowledge-based DBs 256, and the response regulation DBs 258 on the basis of the processing results (the commands) of the natural language processing parts 222. The personal profiles 252 include personal information of an occupant, interests and preferences thereof, personal history of past conversations, and the like, stored for each occupant. The knowledge-based DBs 256 are information that defines a relationship between things. The response regulation DBs 258 are information that defines an operation to be performed by the agent with respect to a command (a reply or contents of instrument control, or the like).

In addition, the conversation management parts 224 may identify the occupant by performing comparison of the personal profiles 252 using the feature information obtained from the voice stream. In this case, in the personal profiles 252, for example, personal information is associated with feature information of the voice. The feature information of the voice is, for example, information associated with features of talking such as a voice pitch, intonation, rhythm (a sound pitch pattern), or the like, or a feature value due to Mel frequency Cepstrum coefficients or the like. The feature information of the voice is, for example, information obtained by an occupant uttering the sound of a predetermined word, sentence, or the like, upon initial registration of the occupant, and recognizing the spoken voice.

The conversation management parts 224 cause the network search parts 226 to perform searching when the command requires information that can be searched for through the network NW. The network search parts 226 access the various types of web servers 500 via the network NW, and acquire desired information. The “information that can be searched for via the network NW” is, for example, an evaluation result of a general user of a restaurant around the vehicle M or a weather forecast according to the position of the vehicle M on that day.

The conversation management parts 224 cause the communication parts 210 to perform transmission of data when a command requires transmission of data to another agent server 200. The conversation management parts 224 determine whether a command contained in the speech of the first user requires transmission of a notification of the first user to another agent server 200, for example, when the speech of the first user is input to the first terminal device 300. Then, the conversation management parts 224 determine the notification of the first user as an object of transmission to the other agent server 200 when it is determined that the command requires transmission of notification of the first user to the other agent server 200. Meanwhile, the conversation management parts 224 instruct the answer sentence generating parts 228 to generate an answer sentence with respect to the first user when it is determined that the command does not require transmission of the notification of the first user to the other agent server 200 and the response to the first user is required.

The answer sentence generating parts 228 generate the answer sentence and transmit the answer sentence to the on-vehicle agent device 100 such that the contents of the speech determined by the conversation management parts 224 are transmitted to the occupant of the vehicle M. The answer sentence generating parts 228 may call the name of the occupant or generate an answer sentence that is made to resemble the speech of the occupant when the occupant is identified as the occupant registered in the personal profile.

The agent function parts 150 perform voice synthesis and instruct the voice controller 118 to output the voice when the answer sentence is acquired. In addition, the agent function parts 150 instruct the display controller 116 to display the image of the agent according to the voice output. As a result, the agent function in which a virtually appearing agent responds to the occupant in the vehicle M is realized.

The transmission switching parts 230 acquire the notification of the first user from the other agent server 200 when it is determined that transmission of the notification of the first user to the other agent server 200 is required by the conversation management parts 224. The transmission switching parts 230 acquire, for example, the notification of the first user from the first terminal device 300 via the agent server 200-1. Then, the transmission switching parts 230 transmit the notification of the first user acquired from the agent server 200-1 to the on-vehicle agent device 100 or the second terminal device 400. The notification of the first user includes at least some of, for example, position information of the first user, action information of the first user, speech contents of the first user, and instruction information to the first user from the second user. The transmission switching parts 230 identify the second user who is a destination of the notification of the first user with reference to the transmission switching DBs 260 stored on the storages 250.

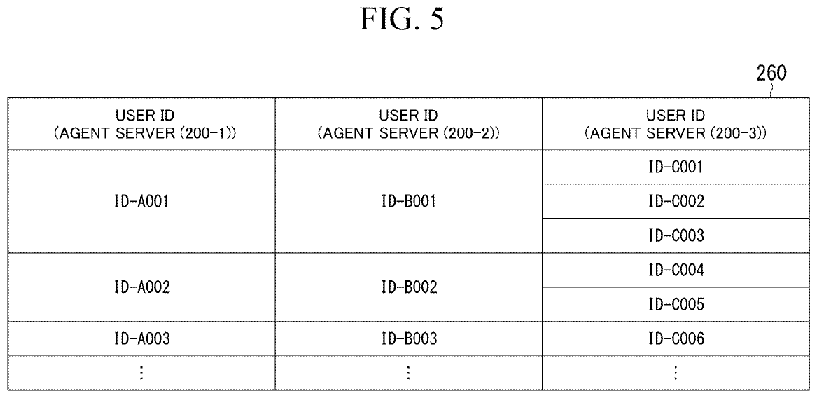

FIG. 5 is a view for describing an example of the transmission switching DB 260. As shown in FIG. 5, the transmission switching DB 260 includes, for example, relation information in which user IDs of the plurality of agent servers 200-1 to 200-3 are associated with each other. In this case, the user ID is identification information used by the agent servers 200-1 to 200-3 to identify the users when the agent functions corresponding to the plurality of agent servers 200-1 to 200-3 are provided to the users. In the example shown in FIG. 5, in the transmission switching DBs 260, “ID-B001” that is a user ID corresponding to the agent server 200-2, and “ID-0001,” “ID-0002” and “ID-0003” that are user IDs corresponding to the agent server 200-3 are associated with “ID-A001” that is a user ID corresponding to the agent server 200-1. Further, the number of the user ID associated with the user ID corresponding to the agent server 200-1 and the user ID corresponding to the agent server 200-2 or the agent server 200-3 may be one or may be plural. When a plurality of user IDs corresponding to the agent server 200-2 or the agent server 200-3 are associated with the user ID corresponding to the agent server 200-1, priority may be set to the plurality of user IDs. The priority may be manually set by, for example, a user, or may be automatically set according to a use frequency or the like of the agent function for each of the agent servers 200-1 to 200-3.

The transmission switching parts 230 acquire the user ID of the first user authenticated by the first terminal device 300 from the first terminal device 300 via the agent server 200-1. Further, the first terminal device 300 authenticates the user ID of the first user by executing, for example, face authentication, voiceprint authentication, or the like, with respect to the first user. Then, the transmission switching parts 230 identify the user ID of the second user associated with the user ID of the first user with reference to the transmission switching DB 260.

When the user ID of the second user is identified, the transmission switching parts 230 require the on-vehicle agent device 100 corresponding to the identified user ID to perform confirmation of existence of the second user. In this case, the transmission switching parts 230 identify, for example, a vehicle ID associated with the user ID of the second user corresponding to the agent server 200-2 with reference to the transmission switching DBs 260.

Then, the transmission switching parts 230 determine the on-vehicle agent device 100 of the vehicle M which the second user will board based on the identified vehicle ID. In addition, the transmission switching parts 230 identify, for example, a terminal ID associated with the user ID of the second user corresponding to the agent server 200-2 with reference to the transmission switching DBs 260. Then, the transmission switching parts 230 determine the second terminal device 400 used by the second user based on the identified terminal ID.

The transmission switching parts 230 select a destination of the notification of the first user on the basis of the recognition result of the existence of the second user acquired from the on-vehicle agent device 100. That is, the transmission switching parts 230 select a destination of the notification of the first user on the basis of whether the second user is on the vehicle M. In this case, the on-vehicle agent device 100 acquires, for example, the recognition result of the existence of the second user from the occupant recognition device 80. Then, the transmission switching parts 230 select the on-vehicle agent device 100 as the destination of the notification of the first user when existence of the second user is recognized by the on-vehicle agent device 100. In addition, the transmission switching parts 230 select the second terminal device 400 used by the second user as the destination of the notification of the first user when existence of the second user is not recognized by the on-vehicle agent device 100. Further, when there are a plurality of second terminal devices 400 used by the second user, for example, the second terminal device 400 having the highest priority may be selected as the destination of the notification of the first user. In addition, the transmission switching parts 230 may select the destination of the notification of the first user on the basis of existence of the second user recognized by the second terminal device 400.

### Processing Flow of Agent Server

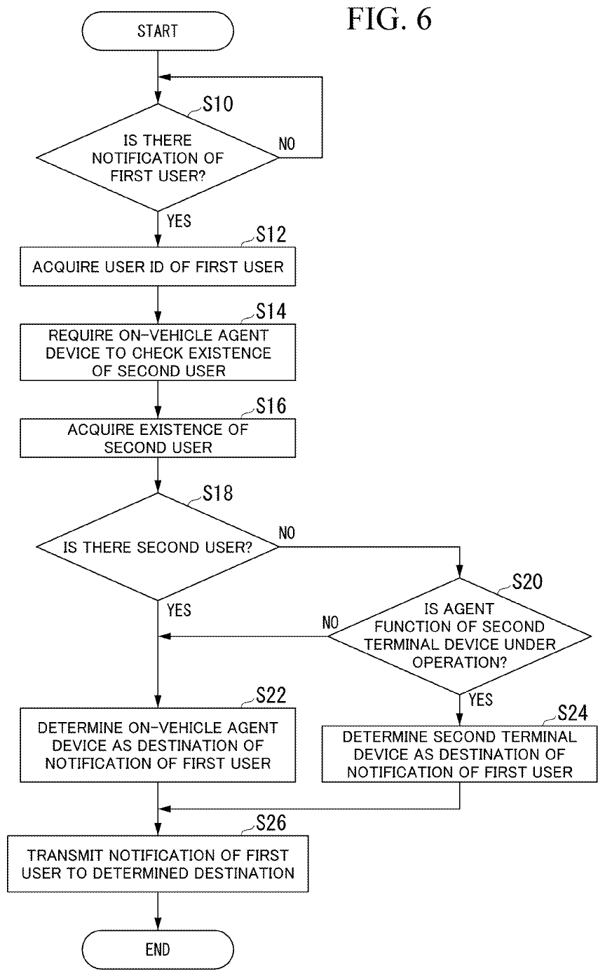

Hereinafter, a flow of a series of processing of the agent server 200-2 according to the embodiment will be described using a flowchart. FIG. 6 is a flowchart for describing the flow of the series of processing of the agent server 200-2 according to the embodiment. The processing of the flowchart may be, for example, repeatedly executed at predetermined time intervals.

First, the transmission switching parts 230 determine whether the notification of the first user is acquired from the agent server 200-1 (step S10). The transmission switching parts 230 acquire the user ID of the first user from the agent server 200-1 when it is determined that the notification of the first user is acquired (step S12). Next, the transmission switching parts 230 require the on-vehicle agent device 100 to check existence of the first user (step S14). Then, the transmission switching parts 230 acquire existence of the second user recognized by the on-vehicle agent device 100 (step S16). The transmission switching parts 230 determine whether existence of the second user is recognized by the on-vehicle agent device 100 (step S18). The transmission switching parts 230 determine the on-vehicle agent device 100 as the destination of the notification of the first user when it is determined that the second user has been recognized by the on-vehicle agent device 100 (step S22). Meanwhile, the transmission switching parts 230 determine whether the agent function of the second terminal device 400 is under operation when the existence of the second user has not been recognized by the on-vehicle agent device 100 (step S20). The transmission switching parts 230 determine the second terminal device 400 as the destination of the notification of the first user when it is determined that the agent function of the second terminal device 400 is under operation (step S24). Meanwhile, the transmission switching parts 230 determine the on-vehicle agent device 100 as the destination of the notification of the first user when it is determined that the agent function of the second terminal device 400 is not under operation (step S22). Then, the transmission switching parts 230 transmit the notification of the first user to the on-vehicle agent device 100 or the second terminal device 400 determined as the destination (step S26). Accordingly, processing of the flowchart is terminated.

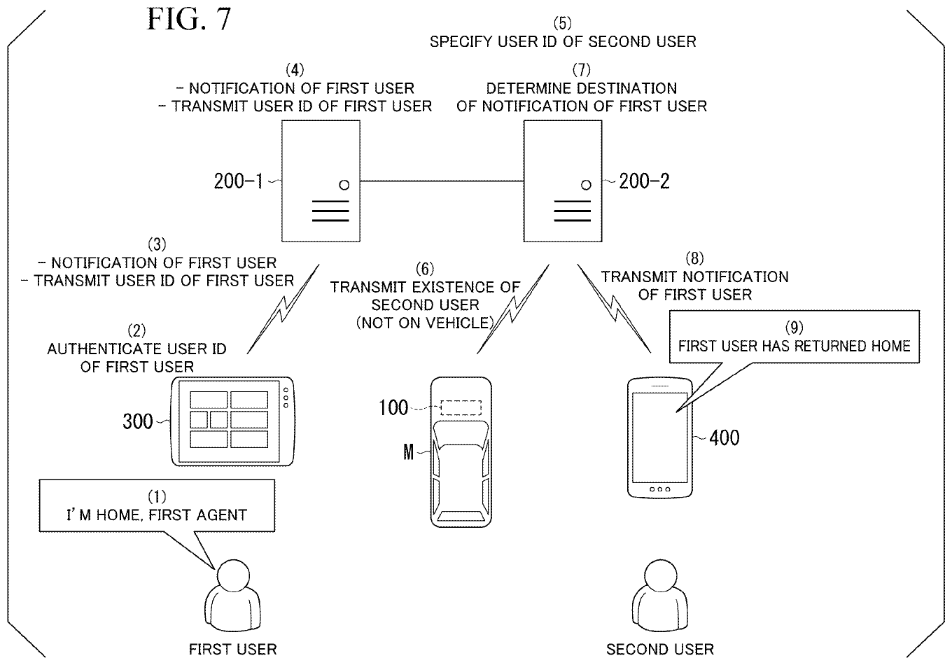

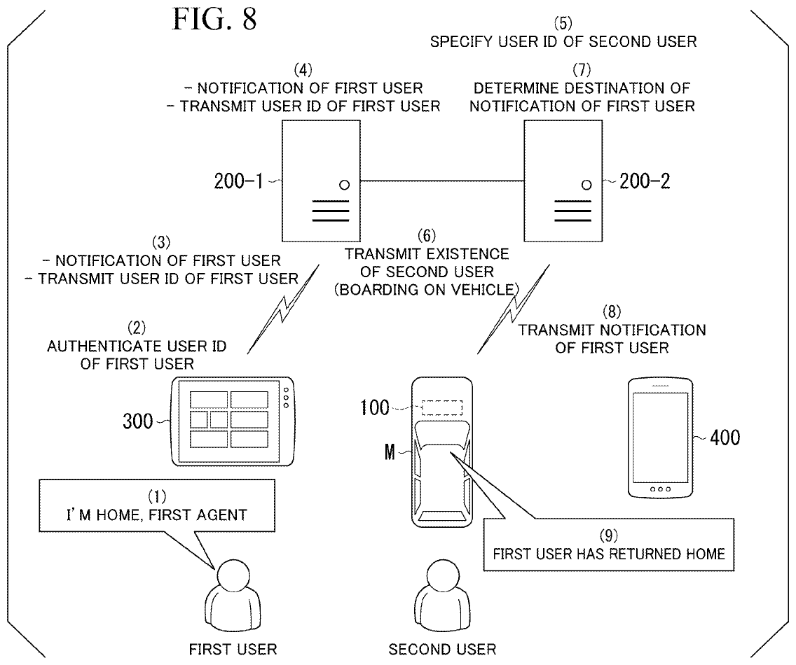

FIG. 7 is a view for describing an operation of the agent system 1 according to the embodiment. (1) to (9) shown in FIG. 7 indicate sequential orders of a flow of the operations. Hereinafter, the operation will be described together with the sequential order. FIG. 8, which will be described below, is the same as above. Further, in an example shown in FIG. 7 and FIG. 8, for example, the following description assumes that the first user is a child and the second user is a parent.

(1) The first terminal device 300 receives a speech input of “I'm home, a first agent” indicating that the first user has returned home. (2) The first terminal device 300 authenticates the user ID of the first user who inputs speech. (3) The first terminal device 300 transmits the notification of the first user indicating that the first user has returned home to the agent server 200-1 together with the user ID of the first user when the user ID of the first user is authenticated. (4) The agent server 200-1 transmits the user ID of the first user acquired from the first terminal device 300 to the agent server 200-2 together with the notification of the first user acquired from the first terminal device 300.

(5) The agent server 200-2 identifies the user ID of the second user associated with the user ID of the first user with reference to the transmission switching DBs 260 when the user ID of the first user is acquired from the agent server 200-1. Then, the agent server 200-2 requires the on-vehicle agent device 100 corresponding to the user ID of the second user to check existence of the second user. (6) The on-vehicle agent device 100 transmits a recognition result of existence of the second user who gets on the vehicle M to the agent server 200-2.

In the example shown in FIG. 7, the on-vehicle agent device 100 transmits the recognition result indicating that the second user is not recognized to the agent server 200-2. (7) The agent server 200-2 determines the second terminal device 400 as the destination of the notification of the first user when the recognition result indicating that the second user is not recognized is acquired from the on-vehicle agent device 100. (8) In addition, the agent server 200-2 transmits the notification of the first user to the second terminal device 400 determined as the destination. (9) Then, the second terminal device 400 notifies a message of “the first user has returned home!” indicating that the first user has returned home to the second user when the notification of the first user is acquired from the agent server 200-2.

FIG. 8 is a view for describing an operation of the agent system 1 according to the embodiment.

(1) The first terminal device 300 receives a speech input of “I'm home, a first agent” indicating that the first user has returned home. (2) The first terminal device 300 authenticates the user ID of the first user who inputs the speech. (3) The first terminal device 300 transmits the notification of the first user indicating that the first user has returned home to the agent server 200-1 together with the user ID of the first user when the user ID of the first user is authenticated. (4) The agent server 200-1 transmits the user ID of the first user acquired from the first terminal device 300 to the agent server 200-2 together with the notification of the first user acquired from the first terminal device 300.

(5) The agent server 200-2 identifies the user ID of the second user associated with the user ID of the first user with reference to the transmission switching DBs 260 when the user ID of the first user is acquired from the agent server 200-1. Then, the agent server 200-2 requires the on-vehicle agent device 100 corresponding to the user ID of the second user to check existence of the second user. (6) The on-vehicle agent device 100 transmits a recognition result of existence of the second user who is boarding on the vehicle M to the agent server 200-2.

In the example shown in FIG. 8, the on-vehicle agent device 100 transmits the recognition result indicating that the second user is recognized to the agent server 200-2. (7) The agent server 200-2 determines the on-vehicle agent device 100 as the destination of the notification of the first user when the recognition result indicating that the second user is recognized is acquired from the on-vehicle agent device 100.

(8) In addition, the agent server 200-2 transmits the notification of the first user to the on-vehicle agent device 100 determined as the destination. (9) Then, the on-vehicle agent device 100 notifies a message of “the first user has returned home!” indicating that the first user has returned home to the second user when the notification of the first user is acquired from the agent server 200-2.

Further, in the example shown in FIG. 7 and FIG. 8, the example in which the notification of the first user is transmitted from the first terminal device 300 to the on-vehicle agent device 100 or the second terminal device 400 has been exemplarily described. However, when the speech of the first user is input to the on-vehicle agent device 100 or the second terminal device 400, the notification of the first user may be transmitted from the on-vehicle agent device 100 or the second terminal device 400 to the first terminal device 300.

In addition, in the example shown in FIG. 7 and FIG. 8, the case in which, regardless of existence of a request from the second user, when the speech of the first user is input to the first terminal device 300, the notification of the first user is transmitted, has been exemplarily described. However, under a condition in which a request of the notification of the first user is input by the second user through the on-vehicle agent device 100 or the second terminal device 400, the notification of the first user may be transmitted from the first terminal device 300 to the on-vehicle agent device 100 or the second terminal device 400.

In addition, in the example shown in FIG. 7 and FIG. 8, the example of the case in which the destination of the notification of the first user is switched between the on-vehicle agent device 100 and the second terminal device 400 on the basis of whether the second user is recognized by the on-vehicle agent device 100 has been exemplarily described. However, even if the second user is recognized by the on-vehicle agent device 100, when the second user is present on a driver's seat of the vehicle M, the second terminal device 400 may be determined as the destination of the notification of the first user instead of the on-vehicle agent device 100.

According to the agent system 1 of the embodiment described above, provision of the agent function can be performed accurately. For example, even if the notification of the first user is transmitted to the on-vehicle agent device 100 mounted on the vehicle M via the network NW, when the second user is not on the vehicle M, the notification from the first user may not be transmitted to the second user through provision of the agent function. On the other hand, according to the agent system 1 of the embodiment, when the on-vehicle agent device 100 mounted on the vehicle M recognizes existence of the second user and the second user is not recognized by the on-vehicle agent device 100, the notification from the first user is transmitted to the second terminal device 400 used by the second user.

For this reason, the notification from the first user can be accurately transmitted to the second user through provision of the agent function.

In addition, according to the agent system 1, provision of the agent function can be more accurately performed. For example, when the second user operates the vehicle M to drive, even if the notification from the first user is transmitted to the second terminal device 400 used by the second user, the second user may not be able to notice the notification from the first user. On the other hand, according to the agent system 1 of the embodiment, when the second user is recognized by the on-vehicle agent device 100, the notification from the first user is transmitted to the on-vehicle agent device 100, and the notification from the first user is transmitted to the second user through the agent function provided by the on-vehicle agent device 100. For this reason, the notification from the first user to the second user can be more accurately performed through provision of the agent function.

In addition, according to the agent system 1, provision of the agent function can be more accurately performed. For example, when the notification of the first user is performed through an electronic mail, even if the notification of the first user is transmitted to the second user, the contents of the notification of the first user are not necessarily confirmed by the second user. On the other hand, according to the agent system 1 of the embodiment, since the notification of the first user is performed through conversation with the first user by the agent function, the notification of the first user can be more accurately transmitted to the second user.

In addition, according to the agent system 1, provision of the agent function can be more accurately performed. For example, even if the agent function of the second terminal device 400 used by the second user is not running, when the second terminal device 400 is determined as the destination of the notification from the first user, notification from the first user to the second terminal device 400 may not be transmitted from the agent server 200-2. On the other hand, according to the agent system 1 of the embodiment, even if the second user is not recognized by the on-vehicle agent device 100, when the second terminal device 400 is not operating, the on-vehicle agent device 100 is determined as the destination of the notification from the first user. For this reason, the notification from the first user can be more accurately transmitted to the second user through provision of the agent function.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An agent system comprising:
a first agent application that causes a first terminal device used by a first user to function as a first agent device configured to provide a service including causing an output section to output a response by a voice in response to a speech of the first user;
a first server device configured to communicate with the first terminal device;
a second agent application that causes a second terminal device used by a second user to function as a second agent device configured to provide a service including causing an output section to output a response by a voice in response to a speech of the second user;
an on-vehicle agent device mounted on a vehicle and used by the second user; and
a second server device configured to communicate with the second terminal device, the on-vehicle agent device and the first server device,
wherein the first server device transmits information associated with a speech of the first user acquired from the first terminal device to the second server device, and
the second server device transmits information associated with the speech of the first user acquired from the first server device to the second terminal device or the on-vehicle agent device on the basis of existence of the second user recognized by the second terminal device or the on-vehicle agent device.

2. The agent system according to claim 1, wherein the second server device transmits information associated with the speech of the first user to the on-vehicle agent device when the second user is recognized by the on-vehicle agent device.

3. The agent system according to claim 1, wherein the second server device transmits information associated with the speech of the first user to the second terminal device when the second user is recognized by the second terminal device.

4. The agent system according to claim 2, wherein the second server device transmits information associated with the speech of the first user to the on-vehicle agent device or the second terminal device provided that the information associated with the speech of the first user is determined as an object to be transmitted to the second user.

5. A server device that functions as a first server device which is configured to communicate with a first terminal device that functions as a first agent device configured to provide a service including causing an output section to output a response by a voice in response to a speech of a first user, a second terminal device which functions as a second agent device configured to provide a service including causing an output section to output a response by a voice in response to a speech of a second user, and a second server device which is configured to communicate with an on-vehicle agent device mounted on a vehicle and used by the second user,
wherein the first server device acquires information associated with the speech of the first user acquired from the first terminal device, and transmits information associated with the speech of the first user acquired from the first server device to the second terminal device or the on-vehicle agent device on the basis of existence of the second user recognized by the second terminal device or the on-vehicle agent device.

6. A method of controlling an agent system, which is performed by one or a plurality of computers, the method comprising:
providing a service including causing an output section to output a response by a voice in response to a speech of a first user through a first terminal device used by the first user;
providing a service including causing an output section to output a response by a voice in response to a speech of a second user through a second terminal device used by the second user;
recognizing existence of the second user through an on-vehicle agent device mounted on a vehicle and used by the second user or the second terminal device; and
transmitting information associated with the speech of the first user to the second terminal device or the on-vehicle agent device on the basis of existence of the second user.

7. A computer-readable non-transient storage medium storing a program executed in one or plurality of computers, the program stored in the computer-readable non-transient storage medium comprising:
processing of providing a service including causing an output section to output a response by a voice in response to a speech of a first user through a first terminal device used by the first user;
processing of providing a service including causing an output section to output a response by a voice in response to a speech of a second user through a second terminal device used by the second user;
processing of recognizing existence of the second user through an on-vehicle agent device mounted on a vehicle and used by the second user or the second terminal device; and
processing of transmitting information associated with the speech of the first user to the second terminal device or the on-vehicle agent device on the basis of existence of the second user.
